(19) United States
(12) Patent Application Publication
(10) Pub. No.: US 2016/0253480 A1
(43) Pub. Date: Sep. 1, 2016

(54) System and Method for Matching Patients with Clinical Trials

(71) Applicant: BioNews Services, LLC, Dallas, TX (US)

(72) Inventor: Chris Comish, Dallas, TX (US)

(21) Appl. No.: 15/055,610

(22) Filed: Feb. 28, 2016

Related U.S. Application Data
(60) Provisional application No. 62/126,566, filed on Feb. 28, 2015.

(51) Int. Cl. G06F 19/00; G06F 17/30; G06Q 50/00

(52) U.S. Cl. CPC G06F 19/363; G06Q 50/01; G06F 17/30241; G06F 17/30882

(57) ABSTRACT

The current invention discloses improved systems and processes for increasing clinical trial enrollment. Information for a clinical trial is received, such as the disease or condition under investigation and the pharmaceutical, device, or therapy under investigation and stored as a clinical trial record. Patient relevant sections and keywords are extracted from the clinical trial record. Sections and keywords within the clinical trial record are mapped to more common layman keywords. An article is composed based on the clinical trial record. The composed article is published and pushed to various outlets with an embedded tracking unique identifier for each outlet. Click interaction with the composed article is monitored. Upon click interaction with the article, the embedded link leads the patient to a clinical trial enrollment inquiry destination. The source outlet for the patient clinical trial enrollment contact is determined by lookup with the embedded identifier. The patient is contacted for follow up on possible clinical trial enrollment where additional acceptance criteria questions may be posed or he or she is notified of clinical trial eligibility.

The present application claims the benefit of U.S. Provisional Application Ser. No. 62/126,566, entitled “System and Method for Matching Patients with Clinical Trials”, filed Feb. 28, 2015, which is incorporated herein by reference.

### BACKGROUND

I. Field of the Invention

The present invention relates to a system and method for matching patients with clinical trials, more specifically, to a system and method for maximizing patient enrollment in clinical trials.

II. Description of Related Art

Many companies sponsor clinical trials for new drugs, medical devices, therapies, or treatment programs. Typical clinical trial sponsors include pharmaceutical companies, biotech companies, medical device companies, clinical research organization, and site management organizations. Clinical trials are often an important step before obtaining FDA approval for particular drugs or otherwise validating a new medical technology.

Unfortunately today, there is not an efficient system for matching patients with clinical trials. Patients who have been diagnosed with a disease often need to find appropriate clinical trials for new drugs, medical devices, or treatments to treat their disease. Often the patient relies on the doctor or other medical staff to inform them of relevant clinical trials. Doctors are often not aware of all the clinical trials that are being performed.

Clinical trial sponsors often have difficulty finding suitable patients for their trials because there is a lack of exposure to patients who, for example, are geographically dispersed. Additionally, patients or loved ones seeking to find clinical trials on their own often suffer from consumer confusion with regard to medical terminology and protocol information, and thus have a difficult time identifying appropriate clinical trials.

Clinical trial sponsors are also hurt by this problem, since the inability to find acceptable patients to enroll in their clinical trials delays validation of their new drugs or devices and delays FDA approval.

### SUMMARY

Principles of the present disclosure provide systems and processes for increasing clinical trial enrollment or increasing the rate at which clinical trials enroll. In one embodiment a disease or disorder specific article is prepared and published. Within the article or on the page hosting the article are links to information about relevant clinical trials. The links may also direct to a contact form for patients to either obtain additional information about the clinical trial or request or obtain information about trial enrollment. In some embodiments the article is hosted on a disease-specific website. In some embodiments the disease-specific website includes links to clinical trials information and/or links to a contact form a patient may complete and submit to request additional relevant information about the trial.

In one embodiment, information for a clinical trial is received, such as the disease or condition under investigation and the pharmaceutical, device, or therapy under investigation. The information is stored as a clinical trial record. Patient relevant sections and keywords are extracted from the clinical trial record. Sections and keywords within the clinical trial record are mapped to more common layman keywords. An article is composed based on the clinical trial record. The composed article is published and pushed to various media with an embedded tracking unique identifier for each medium. Click interaction with the composed article is monitored. Upon click interaction with the article, the embedded link leads the patient to a clinical trial enrollment inquiry destination. The source medium for the patient clinical trial enrollment contact is determined by lookup, using the embedded identifier as a key. The patient is contacted for follow up on possible clinical trial enrollment where additional acceptance criteria questions may be posed or he or she is notified of clinical trial eligibility.

In one embodiment principles of the present disclosure provide a process of matching patients with clinical trials, the process comprising the steps of creating a disease focused website comprising a plurality of articles regarding current or historical information about a disease, pushing new article published at said website to a plurality of social media platforms, wherein said article contains at lease one link to said website and capturing user information at said website, whereby said user inputs user biographical information into a form at said website.

It is contemplated that any embodiment of a method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternative are mutually exclusive, although the disclosure supports a definition that refers to only alternatives and “and/or.”

Throughout this application, the term “about” is used to indicate that a value includes the standard deviation of error for the device or method being employed to determine the value.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description. Various example embodiments of the present invention are discussed in detail below with reference to the accompanying drawings, in which example embodiments of the present invention are shown. While specific implementations are discussed, this is done for illustration purposes only. A person of ordinary skill in the relevant art will recognize that other components and configurations maybe used without departing from the spirit and scope the present invention. Like numbers refer to like elements throughout.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 is a block diagram depicting major elements of an embodiment of a system for matching patients with clinical trials.

FIG. 2 is a flow chart depicting an embodiment of a process of matching patients with clinical trials.

FIG. 3 is a flow chart depicting an embodiment of a process of matching patients with clinical trials.

FIGS. 4a and 4b are illustrations of a configuration of a subset of the article creation process of matching patients with clinical trials.

FIG. 5 is a flow chart depicting a configuration of a subset of the article publication process of matching patients with clinical trials.

FIG. 6 is a flow chart depicting a configuration of a subset of the patient contact steps of matching patients with clinical trials.

FIG. 7 is a block diagram of an illustrative electronic device for effecting the clinical trials system in accordance with some embodiments of the invention;

### DESCRIPTION

Various systems and processes of the present invention bring patients together with clinical trials by increasing exposure of the clinical trial. Clinical trial sponsors include pharmaceutical companies, biotech companies, and medical device companies. The invention benefits clinical trial sponsors by allowing them to quickly find, prescreen and recruit suitable patients for their clinical trials. The invention thus allows the trial sponsors to accelerate the conduct and completion of their clinical trials in order to obtain FDA approval or demonstrate additional efficiency for particular drugs or devices. By accelerating the conduct and completion of clinical trials, these companies can effectively reduce costs and speed up time to market.

Various embodiments of systems and processes of the present invention brings patients together with clinical trials by increasing exposure of clinical trials to patients, patients' families, health care professionals, and others involved. Various embodiments receive information about an available trial, compose an article describing the trial, publish the composed article, broadcast the composed article, monitor patient interaction with composed article for clinical trial inquiry, receive the patient information, and screen the patient to determine whether a patient prequalifies for particular trials. Once the system of the present invention determines that a patient prequalifies for a particular clinical trial site, the patient is then provided additional information or placed in contact with the clinical trial site so that the patient can enroll in the clinical trial. Tracking and compensation can occur via article and source identifiers associated with the article.

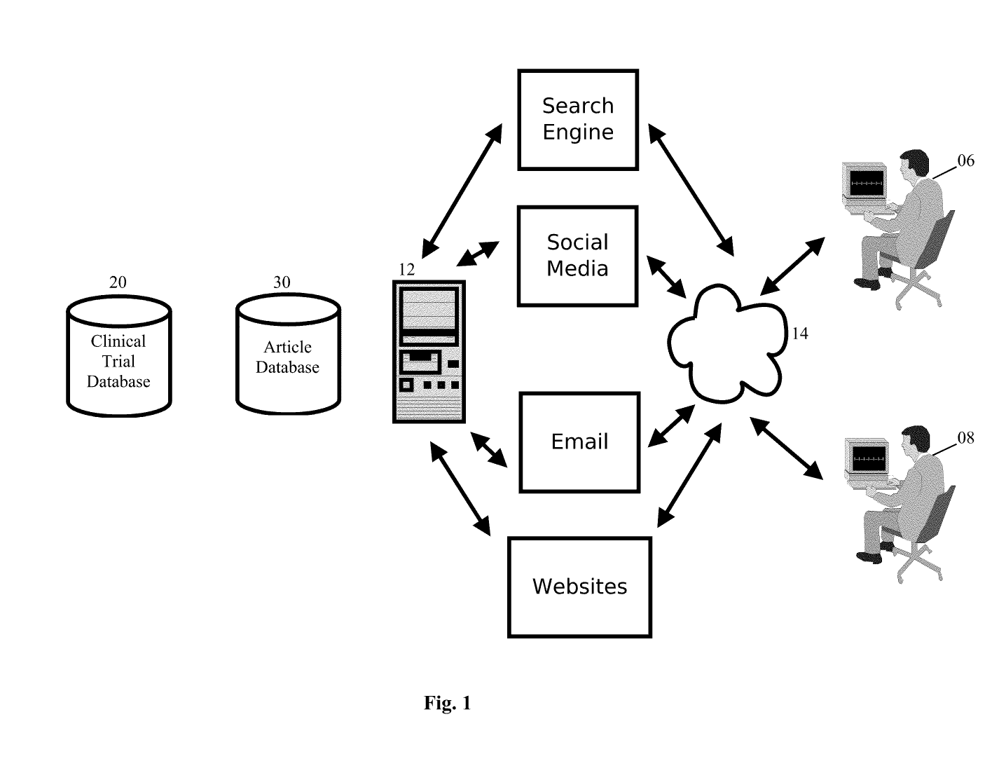

FIG. 1 depicts a block diagram having major components of an exemplary embodiment. It contains optional elements. The depicted embodiment is carried out on computing equipment, although it is within the scope of this invention to carry it out otherwise. Depicted are a server 12, a clinical trial database 20, and an article database 30. Clinical trial sponsors 06 and patients 08 communicate with the server 12 and other resources over a network 14 via workstations 04.

Server 12 includes a CPU, memory, and a data storage device. The data storage device can be any magnetic or optical media, or any other medium for storing electronic data. As would be understood by one skilled in the art, the server 12 can comprise multiple servers working together, and the data storage device can similarly comprise multiple storage devices. The server is embedded with the instruction set of various processes of the current invention.

The clinical trial database 20 contains individual clinical trials records 22. It can contain the purpose of the clinical trial, the question for investigation, the sponsor's name and information, investigator's name and information, trial location, number of patients to be admitted, open or closed status, drug or device being tested, dates and duration of the trial, phases of the trial, trial methodology, and any other information relevant to the clinical trial being performed. The clinical trial records 22 may also contain patient information such as patient acceptance criteria. Patient information can include user name, user ID number, login name, password, contact information, links to patient profiles, and any other similar user information. One type of patient acceptance is administered as patient background questions for patients seeking to enroll in the clinical trial. Representative questions include, but are not limited to, various types of medical information about patients including their age, sex, medical histories, diseases, symptoms, and any other relevant medical information.

The article database 30 contains articles 32 generated for presentation to patients, patients' families, health care professionals, and others involved in the patient's caretaking process. In some instances the article 32 corresponds to and is based on a clinical trial record 22. The article 32 may contain portions of the clinical trial record 22, such as the disease or device under investigation, the disease or condition under investigation, the condition or symptoms being alleviated by the investigation, the demographic affected by the disease or condition, or other related aspects of the clinical trial record 22. In some embodiments the articles may be general disease related articles that provide general information to users/patients.

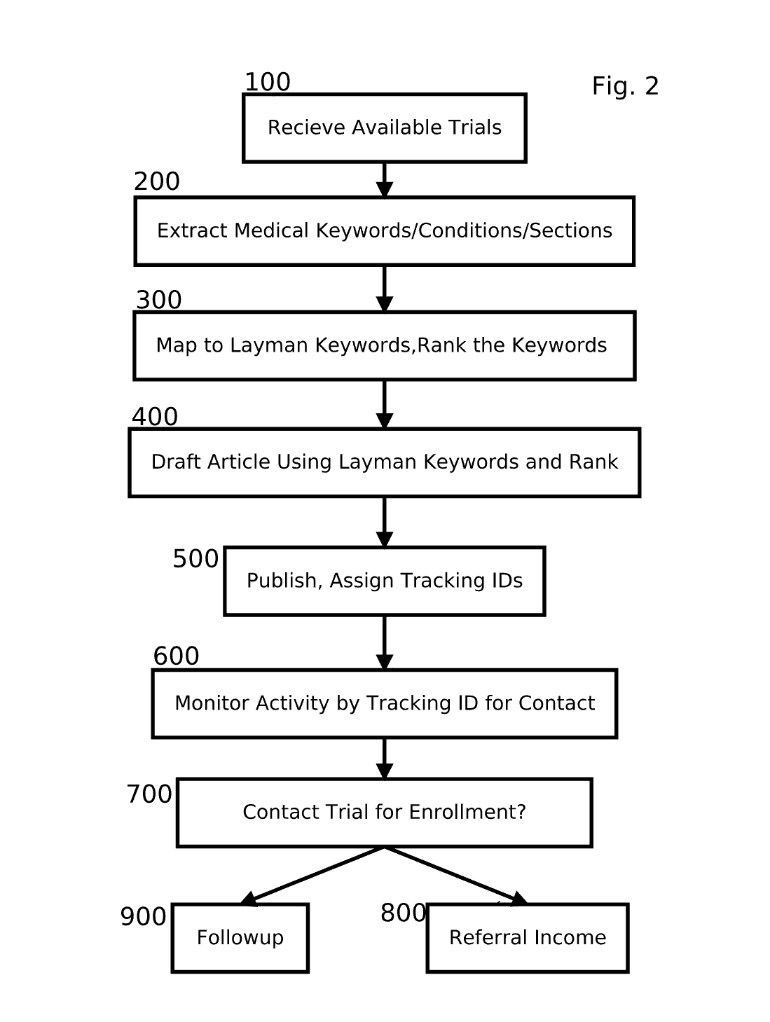

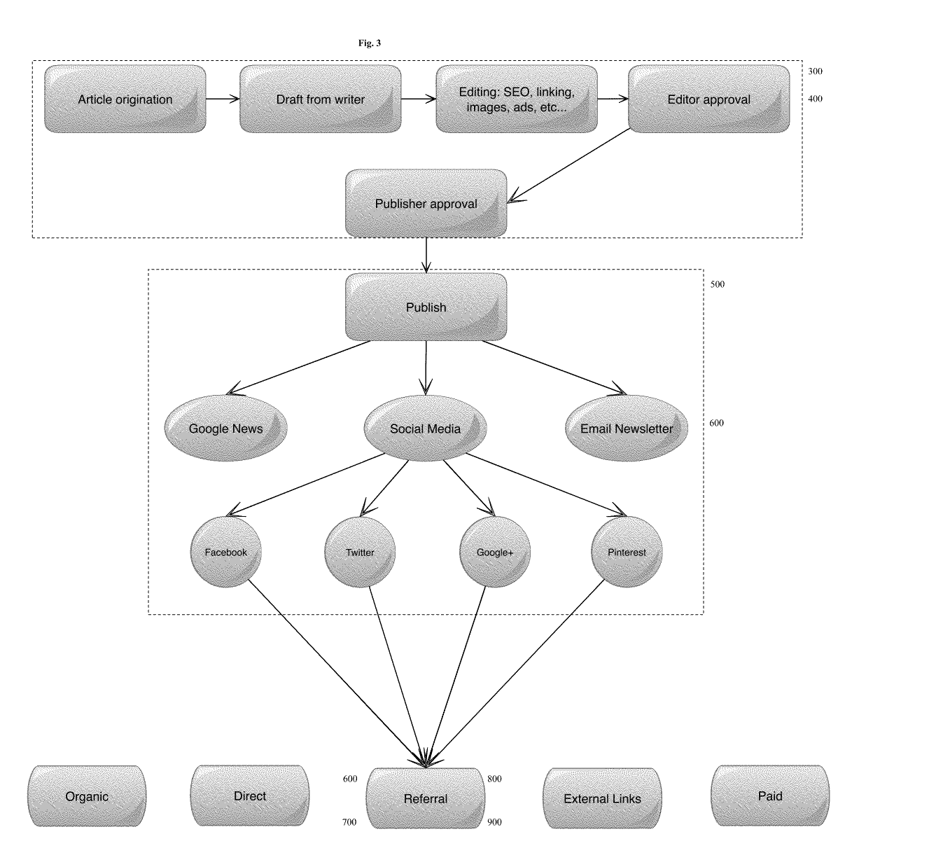

FIGS. 2 and 3 illustrate various embodiments and configurations, some optional, of processes of the current invention. At step 100, information for a clinical trial is received. At step 200, relevant sections and keywords are extracted from the clinical trial record. At step 300, sections and keywords of the clinical trial record are mapped to more common keywords. At step 400, an article is composed based on the clinical trial record. At step 500, the composed article is published with a tracking identifier and destination. At step 600, interaction with the article is monitored. At step 700, the article interaction leads to user interaction of traversing the link to the destination. At step 800, compensation is remunerated according to the identifier. At step 900, the user is contacted for follow up on possible clinical trial enrollment. More consideration to each of the steps will be given below.

At step 100, information for a clinical trial is received. As disclosed above, received clinical trial information can include the purpose of the clinical trial, the question for investigation, the trial methodology, background on the disease or condition being investigated, background on the subject disease or condition, explanations of the subject device, diseases and symptoms and/or conditions alleviated in successful results, sponsor's name and information, investigator's name and information, trial location, number of patients admitted, drug or device or therapy being tested, dates and duration of the trial, phases of the trial, trial methodology, and any other information relevant to the clinical trial being performed. The clinical trial records 22 may also contain patient information such as patient acceptance criteria. One form of patient acceptance is administered as patient background questions for patients seeking to enroll in the clinical trial. Representative questions include, but are not limited to, various types of medical information about patients including their age, race, sex, physical measurements, personal medical histories, family medical history, current and previous medications, current and prior diseases, symptoms, and other relevant medical information. The patient information can include user name, user identification number, login name, password, contact information, links to patient profiles, and any other similar user information. The information is stored as a clinic trial record 22 for further processing.

At steps 200 through 400, article 32 are composed based on the clinical trial records 22. Articles 32 contain are various kinds of content and formats such as newspaper and journal articles, research reports, frequently asked questions, standard therapies, alternate medicine, case studies, blog posts, and various other types of medical information that would be of interest to a patient or someone seeking information about diseases and treatments investigated in the clinic trail.

At step 200, relevant sections and keywords are extracted from the clinical trial record 22. The clinical trial record 22 can contain voluminous amounts of information. It should be understood that it can contain detailed information of relevance to the sponsor, site operators, researchers, investigators, doctors, nurse practitioners, engineers, patients, and others. Generally, the content of the clinical trial record 22 is focused on audiences other than the patient. For example, a clinical trial record 22 for delivery of a novel compound at a joint site for an osteoarthritic condition using a novel device may contain substantial sections for a synthetic chemist, a mechanical engineer, and a surgeon. The section directly geared toward a patient 08 may be minimal. By way of example, in this step of the process, the sections describing the osteoarthritic condition, the symptoms, the anticipated success rate, and success criteria and measures of the clinical trial record 22 may be extracted.

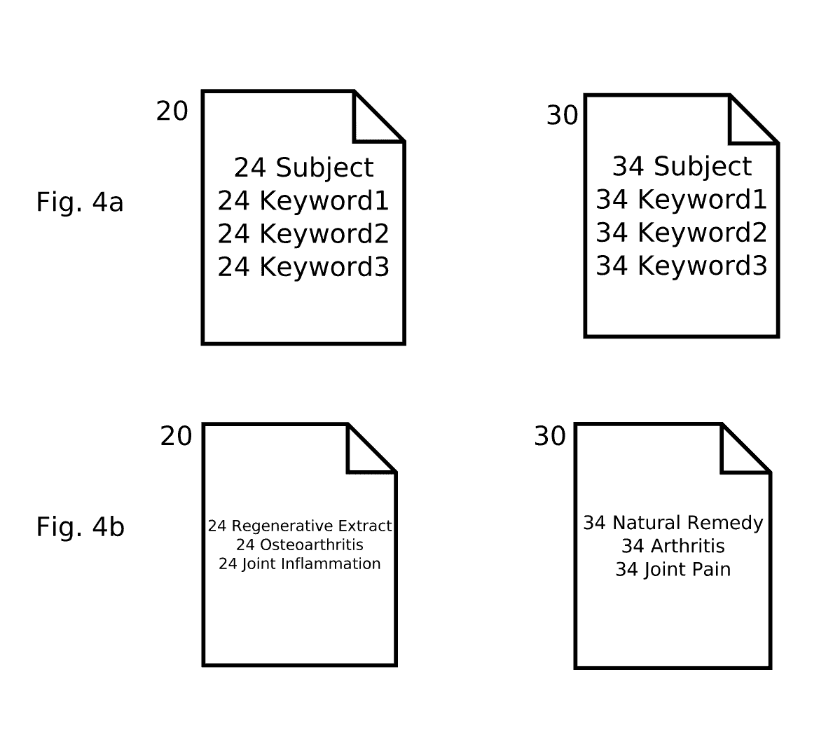

In exemplary process, the article 32 is written in lay terms such that a patient 08 would search upon the terms within the article and comprehend the article 32 to the extent feasible. Referring to FIGS. 4a and 4b, at step 300, the relevant keywords 24 of the clinical trial record 32 are mapped to layman keywords 34. Relevant keywords 24 are those which correspond to those of interest to a target reader, typically, a patient 08. For example, a patient 08 may likely be interested in the subject disease or condition of the clinical trial, the alleviated symptoms or relieved conditions, and the required testing (e.g. medication, therapy, surgery, device implantation, duration of clinical trial). Those selected relevant clinical trial keywords 24 are selected for possible inclusion in the article 32. The selected relevant clinical trial keywords 24 are mapped to layman keywords 34. The clinical trial keywords 24 are mapped to a layman synonym or phrase or mapped to expanded phrases defining the clinical trial keywords 24. This may result in multiple possible lay man keywords 34 for one clinical trial keyword or a lengthy list of layman keywords 34 for consideration for inclusion in the 32. A ranking of the resulting layman keywords 34 may be used to prioritize more frequently used terms using a tool such as the Google Keyword Tool or the like. Other ranking may occur based on the demographic. For example, a where a disease or condition generally impacts a certain age demographic, keywords may be ranked according to the use by the afflicted demographic.

An abbreviated example is shown in FIG. 4b. In the example, a clinical trial record 22 for delivery of an extracted compound directly at a joint site for an osteoarthritic condition. The clinical trial record 22 might contain an example title of “Cartilage Regenerative Extract for Osteoarthritis,” description of the osteoarthritis disorder, reference joint inflammation, and reference a glucosamine extract. The layman keywords 34 might be mapped to “Naturally Derived Remedy for Arthritis,” “arthritis,” and “joint swelling reduction.”

At step 400, an article 32 based on the clinical trial record 22 is composed using the extracted sections and mapped keywords.

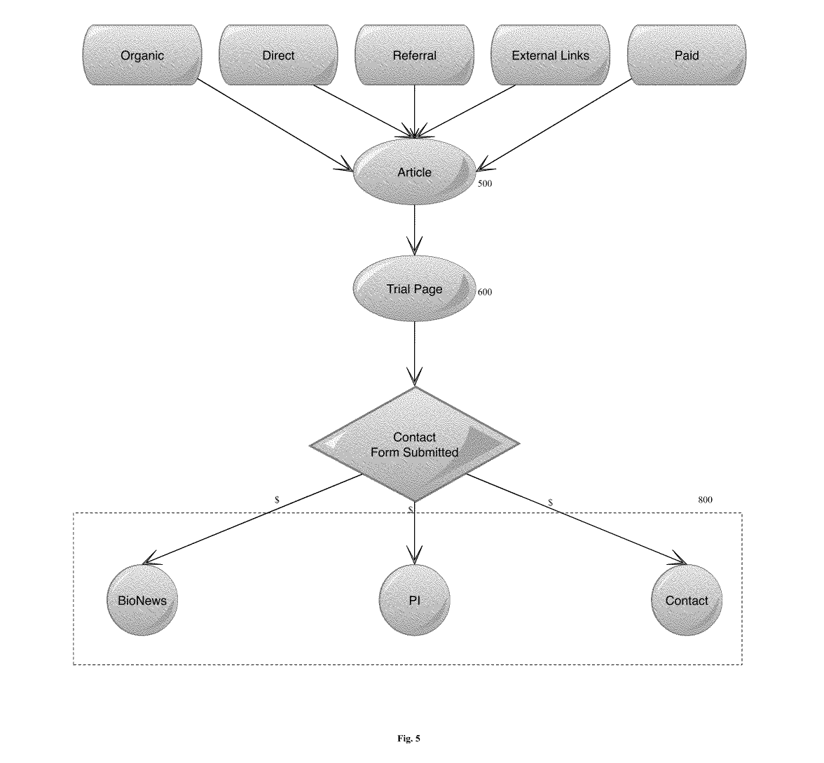

Now referring to FIGS. 1, 3, and 5, the article 32 approaches the published stage. The article 32 may be further edited, optimized, submitted for approval, and approved for publishing. The article 32 is embedded with a link to the clinical trial enrollment destination. At step 500, the article 32 is published. The article 32 is broadcast to various outlets. The article 32 may be published in various media, such as one or more websites, news outlets, directories, and social media such as Facebook, Twitter, Google+, and Pinterest. In exemplary process, the system includes a unique identifier embedded with the link for each outlet, enabling tracking the source of click interaction with the article 32.

At step 600, the system monitors the interaction with the published article 32, specifically monitoring for click interaction with the article 32. A patient 08 or other interested party clicks on the article 32 and following the article 32 to a webpage for the clinical trial enrollment destination link. The user may click the link in an email, go directly to the clinical trial website, search on terms which lead the user to the article 32, be referred from a partner website, or find the link via the social media outlets. The click interaction is logged and the user is presented with information about the clinical trial. Further the interaction on the clinical trial enrollment webpage is also monitored, for contacting the clinical trial administrators in order to enroll. In some embodiments the clinical trials administrators are informed that an interested party has linked to an article and/or has entered biographical information into a form that is maintained in a secure form. In other embodiments the interested party is provided with information about the clinical trials including but not limited to being provided with contact information of clinical trials administrators and locations of clinical trials. In some embodiments the system provides an interested party with the locations that are geographically convenient to the interested party. By geographically convenient is meant within about 10 or 40 or 100 or 300 or 500 miles of the interested party.

As disclosed above, the clinic trial record 22 can contain patient acceptance criteria. The user may be presented questions in order to pre-screen or evaluate the potential patient. Patients 08 who are seeking to join the clinical trial are asked a series of questions about their disease, their prior treatment, and their medical history. The answers to these questions are used to build the patient profile. If the answers to these questions match the acceptance criteria for a specific clinical trial, then the patient becomes eligible to apply for that clinical trial.

The patient 08 profile is saved in the clinical trial record 22 of the clinical trial database 20. Upon completion of the enrollment inquiry, the patient 08 is directed to an industry journal or online media source such as BioNews Texas or BioNews Services, or principal investigator (PI), the clinical trial administrator.

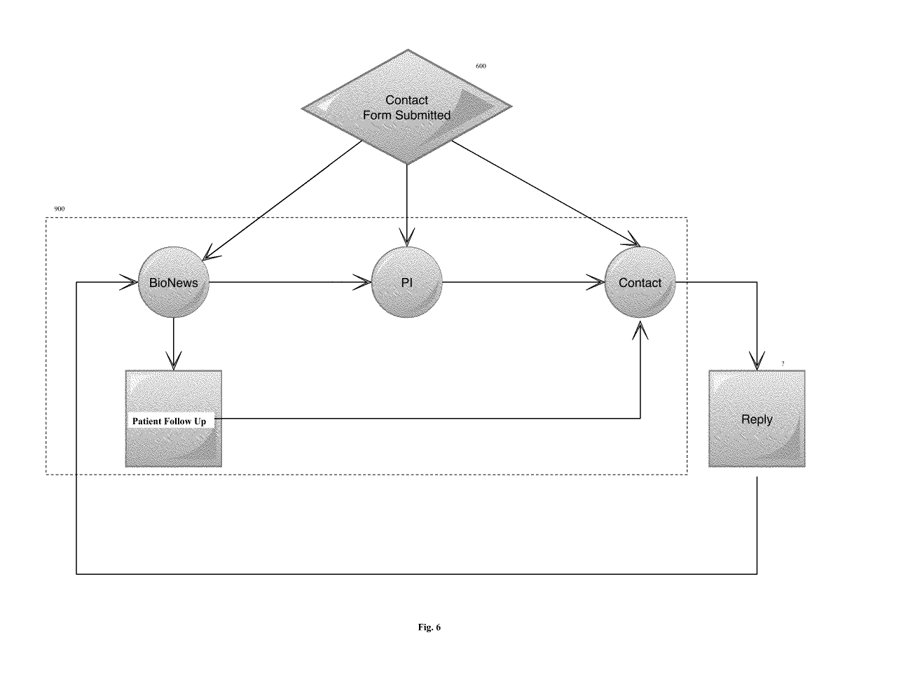

Now referring to FIG. 6, post patient enrollment inquiry is disclosed. At step 800, after the patient 08 submits the enrollment inquiry, the identifier in the embedded link from which the patient 08 arrived at the clinical trial destination is extracted and the source of the article 32 retrieved. Notification and compensation is initiated depending upon the article 32 source which lead to the click interaction.

At step 900, the clinical trial administrator responds to the patient enrollment inquiry. The reply may request additional patient information or notification of eligibility for the clinical trial.

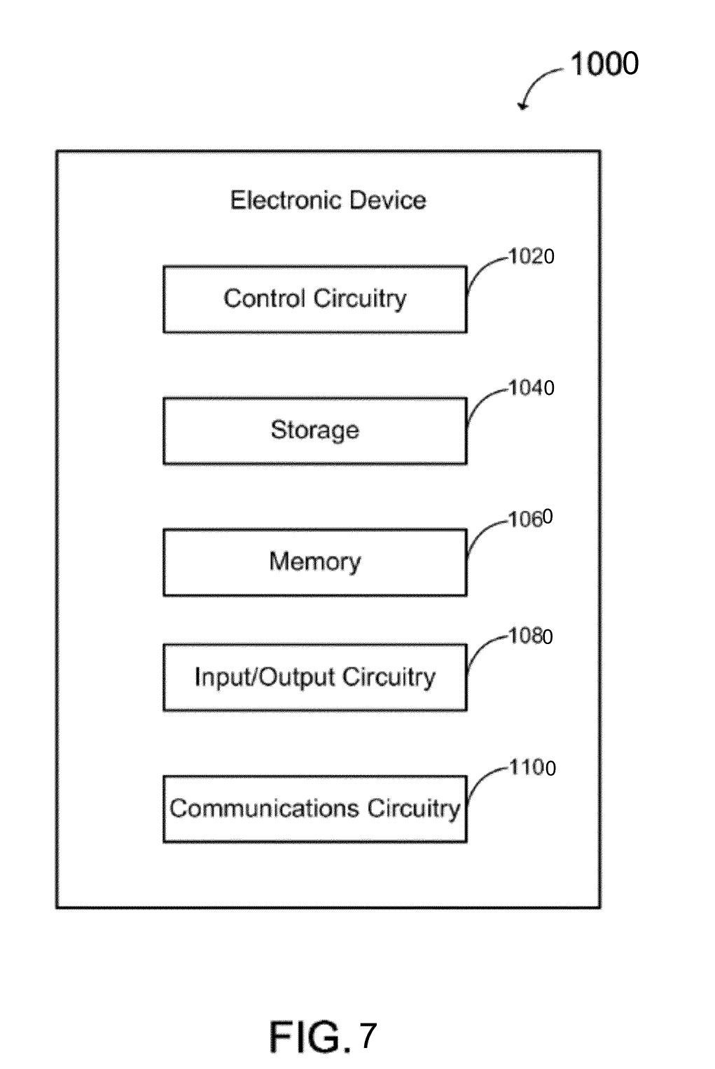

Next, FIG. 7 is a block diagram of an illustrative but not limiting electronic device for providing a system operative for effecting the clinical trials matching system disclosed herein in accordance with some embodiments of the invention. Electronic device 1000 can include control circuitry 1020, storage 1040, memory 1060, input/output (“I/O”) circuitry 1080, and communications circuitry 110. In some embodiments, one or more of the components of electronic device 1000 can be combined or omitted (e.g., storage 1040 and memory 1060 may be combined). In some embodiments, electronic device 1000 can include other components not combined or included in those shown in FIG. 7 (e.g., a power supply such as a battery, a display, bus, a positioning system, an input mechanism, etc.), or several instances of the components shown in FIG. 7. For the sake of simplicity, only one of each of the components is shown in FIG. 7.

Electronic device 1000 can include any suitable type of electronic device. For example, electronic device 1000 can include a portable electronic device that the user may hold in his or her hand, such as a smartphone (e.g., an iPhone made available by Apple Inc. of Cupertino, Calif. or an Android device such as those produced and sold by Samsung). As another example, electronic device 1000 can include a larger portable electronic device, such as a tablet or laptop computer. As yet another example, electronic device 1000 can include a substantially fixed electronic device, such as a desktop computer.

Control circuitry 1020 can include any processing circuitry or processor operative to control the operations and performance of electronic device 1000. For example, control circuitry 1020 can be used to run operating system applications, firmware applications, media playback applications, media editing applications, or any other application. In some embodiments, control circuitry 1020 can drive a display and process inputs received from a user interface.

Storage 1040 can include, for example, one or more storage mediums including a hard-drive, solid state drive, flash memory, permanent memory such as ROM, any other suitable type of storage component, or any combination thereof. Storage 1040 can store, for example, clinical trials data, patient data, application data (e.g., for implementing functions on electronic device 1000), firmware, user preference information data, authentication information, lifestyle information data, transaction information data (e.g., information such as credit card information), wireless connection information data (e.g., information that can enable electronic device 1000 to establish a wireless connection), subscription information data, contact information data (e.g., telephone numbers and email addresses), calendar information data, and any other suitable data or any combination thereof.

Memory 1060 can include cache memory, semi-permanent memory such as RAM, and/or one or more different types of memory used for temporarily storing data. In some embodiments, memory 1060 can also be used for storing data used to operate electronic device applications, or any other type of data that can be stored in storage 1040. In some embodiments, memory 1060 and storage 1040 can be combined as a single storage medium.

I/O circuitry 1080 can be operative to convert (and encode/decode, if necessary) analog signals and other signals into digital data. In some embodiments, I/O circuitry 1080 can also convert digital data into any other type of signal, and vice-versa. For example, I/O circuitry 1080 can receive and convert physical contact inputs (e.g., from a multi-touch screen), physical movements (e.g., from a mouse or sensor), analog audio signals (e.g., from a microphone), or any other input. The digital data can be provided to and received from control circuitry 1020, storage 1040, memory 1060, or any other component of electronic device 1000. Although I/O circuitry 1080 is illustrated in FIG. 7 as a single component of electronic device 1000, several instances of I/O circuitry 1080 can be included in electronic device 1000.

Electronic device 1000 can include any suitable interface or component for allowing a user to provide inputs to I/O circuitry 1080. For example, electronic device 1000 can include any suitable input mechanism, such as for example, a button, keypad, dial, a click wheel, or a touch screen. In some embodiments, electronic device 1000 can include a capacitive sensing mechanism, or a multi-touch capacitive sensing mechanism.

In some embodiments, electronic device 1000 can include specialized output circuitry associated with output devices such as, for example, one or more audio outputs. The audio output can include one or more speakers (e.g., mono or stereo speakers) built into electronic device 1000, or an audio component that is remotely coupled to electronic device 1000 (e.g., a headset, headphones or ear buds that can be coupled to communications device with a wire or wirelessly).

In some embodiments, I/O circuitry 1080 can include display circuitry (e.g., a screen or projection system) for providing a display visible to the user. For example, the display circuitry can include a screen (e.g., an LCD screen) that is incorporated in electronics device 1000. As another example, the display circuitry can include a movable display or a projecting system for providing a display of content on a surface remote from electronic device 1000 (e.g., a video projector). In some embodiments, the display circuitry can include a coder/decoder (CODEC) to convert digital media data into analog signals. For example, the display circuitry (or other appropriate circuitry within electronic device 1000) can include video CODECs, audio CODECs, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 1020. Alternatively, the display circuitry can be operative to provide instructions to a remote display.

Communications circuitry 1100 can include any suitable communications circuitry operative to connect to a communications network and to transmit communications (e.g., voice or data) from electronic device 1000 to other devices within the communications network. Communications circuitry 1100 can be operative to interface with the communications network using any suitable communications protocol such as, for example, Wi-Fi (e.g., a 802.11 protocol), Bluetooth., radio frequency systems (e.g., 900 MHz, 1.4 GHz, and 5.6 GHz communication systems), infrared, GSM, GSM plus EDGE, CDMA, LTE and other cellular protocols, VOIP, or any other suitable protocol.

In some embodiments, communications circuitry 1100 can be operative to create a communications network using any suitable communications protocol. For example, communications circuitry 1100 can create a short-range communications network using a short-range communications protocol to connect to other devices. For example, communications circuitry 1100 can be operative to create a local communications network using the Bluetooth protocol to couple electronic device 100 with a Bluetooth headset.

Electronic device 1000 can include one more instances of communications circuitry 1100 for simultaneously performing several communications operations using different communications networks, although only one is shown in FIG. 7 to avoid overcomplicating the drawing. For example, electronic device 1000 can include a first instance of communications circuitry 1100 for communicating over a cellular network, and a second instance of communications circuitry 1100 for communicating over Wi-Fi or using Bluetooth. In some embodiments, the same instance of communications circuitry 1100 can be operative to provide for communications over several communications networks.

In some embodiments, electronic device 1000 can be coupled a host device for data transfers, synching the communications device, software or firmware updates, providing performance information to a remote source or performing any other suitable operation that can require electronic device 1000 to be coupled to a host device. Several electronic devices 1000 can be coupled to a single host device using the host device as a server. Alternatively or additionally, electronic device 1000 can be coupled to several host devices (e.g., for each of the plurality of the host devices to serve as a backup for data stored in electronic device 1000).

While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the present invention.

We claim:

1. A process of matching patients with clinical trials, the process comprising the steps of:
a. publishing on a disease focused website a plurality of articles regarding current or historical information about a disease;
b. pushing new article published at said website to a plurality of social media platforms, wherein said article contains at lease one link to said website;
c. capturing user information at said website, whereby said user inputs user biographical information into a form at said website.

2. The process according to claim 1, wherein said biographical information is maintained in a confidential fashion.

3. The process according to claim 2, wherein a message is relayed to a clinical trials sponsor informing of a clinical trial candidate.

4. The process according to claim 3, wherein said user consents to being contacted by said clinical trial sponsor.

5. The process according to claim 4, wherein said user is provided contact information of said clinical trial sponsor.

6. The process according to claim 1, further comprising providing said user with geographically convenient clinical trials.

7. The process according to claim 6, wherein said geographically convenient clinical trials are within 10, 50 or 100 miles of said user.

8. On an electronic device, a method for matching patients with clinical trials said method comprising:
a. providing first and second websites containing articles regarding current or historical information about a disease;
b. publishing a new first and second article regarding the disease associated with said first and second website, respectively;
c. disseminating each of said new first and second articles via at least a first and second social media platform, wherein said first and second articles each contain at least one link to said first and second websites, respectively;
d. capturing reader information at each of said first and second websites, wherein upon following said link in said article, said reader provides biographical information to said first or second website.

9. The device according to claim 8, wherein said reader biographical information is stored confidentially.

10. The device according to claim 8, wherein said reader consents to having a clinical trials administrator associated a clinical trial related to the respective disease contact said reader.

11. The device according to claim 8, further comprising clinical trials enrollment criteria.

12. The device according to claim 8, further comprising comparing the reader information to said enrollment criteria and wherein said reader information meets the enrollment criteria informing a clinical trial administrator associated with a clinical trial related to the disease of a potential clinical trial patient.

13. A process for matching patients with clinical trials, the process comprising the steps of:
a. composing a layman article regarding current or historical information about a disease;
b. embedding a hyperlink with a tracking identifier to a clinical trial record in said article;
c. at the hyperlink destination providing a contact form for completion by a clinical trial candidate;
d. submitting a completed contact form to a candidate monitor and to a clinical trials principal investigator.
